(19) United States
(12) Patent Application Publication
(10) Pub. No.: US 2003/0184584 A1
(43) Pub. Date: Oct. 2, 2003

(54) User interface framework for integrating user interface elements of independent software components

(76) Inventors: Thomas Vachuska, Roseville, CA (US); Richard Hagarty JR., Roseville, CA (US); Jesse Hummer, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/113,431

(22) Filed: Mar. 29, 2002

(51) Int. Cl. G09G 5/00

(52) U.S. Cl. 345/762

(57) ABSTRACT

A software framework integrates user interfaces of a plurality independent components into a common graphical user interface (GUI). A first independent component has a Java core framework and first user interface (UI) elements. A second independent component has a Java core framework and second UI elements. A UI framework generates the common GUI. The UI framework includes a base UI component that is a Java core component and that communicates with and integrates the first and second UI elements. The base UI component generates a base application window and provides a set of common UI services. The base application window is a browser-style interface. The UI framework is a Java class library that is built by a set of tools that are based on JavaSwing components.

### FIELD OF THE INVENTION

The present invention relates to user interface frameworks, and more particularly to user interface frameworks that integrate user interface elements of independent software components.

### BACKGROUND OF THE INVENTION

Software providers oftentimes sell a number of different related software applications or components. By combining the software components, the software providers can provide variable functionality for customers at different price points. However, because the software components are independent, the components are often limited in their ability to extend functionality and to integrate with each other. The components are usually designed as point solutions with limited consideration for future expansion. In other words, the software components, when combined, do not really provide an extensible platform. As a result of the failure to provide an extensible platform, marketing flexibility, product quality, and developer efficiency suffer.

In addition, because different developers develop the software components at different times, the user interfaces usually have a different look and feel. The failure to use a common user interface across a range of product functionality adversely impacts the overall user experience. The failure to provide an extensible platform also limits or prevents complimentary functionality.

### SUMMARY OF THE INVENTION

A software framework according to the present invention integrates user interfaces of a plurality independent components into a common graphical user interface (GUI). A first independent component has a Java core framework and first user interface (UI) elements. A second independent component has a Java core framework and second UI elements. A UI framework generates the common GUI. The UI framework includes a base UI component that is a Java core component and that communicates with and integrates the first and second UI elements.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a screen view of a graphical user interface (GUI) that integrates user interface (UI) elements of independent software components and that is generated by the UI framework according to the present invention;

FIG. 2 is a functional block diagram of the UI framework;

FIG. 3 illustrates packages, classes and interfaces that form the UI framework;

FIG. 4 are steps that are performed when launching the BaseUI component;

FIG. 5 illustrates a navigation object;

FIG. 6 illustrates a Java core framework; and

FIG. 7 illustrates service providers and service consumers in the Java core framework.

### DETAILED DESCRIPTION OF THE PREFERRED EMBODIMENTS

The following description of the preferred embodiment(s) is merely exemplary in nature and is in no way intended to limit the invention, its application, or uses.

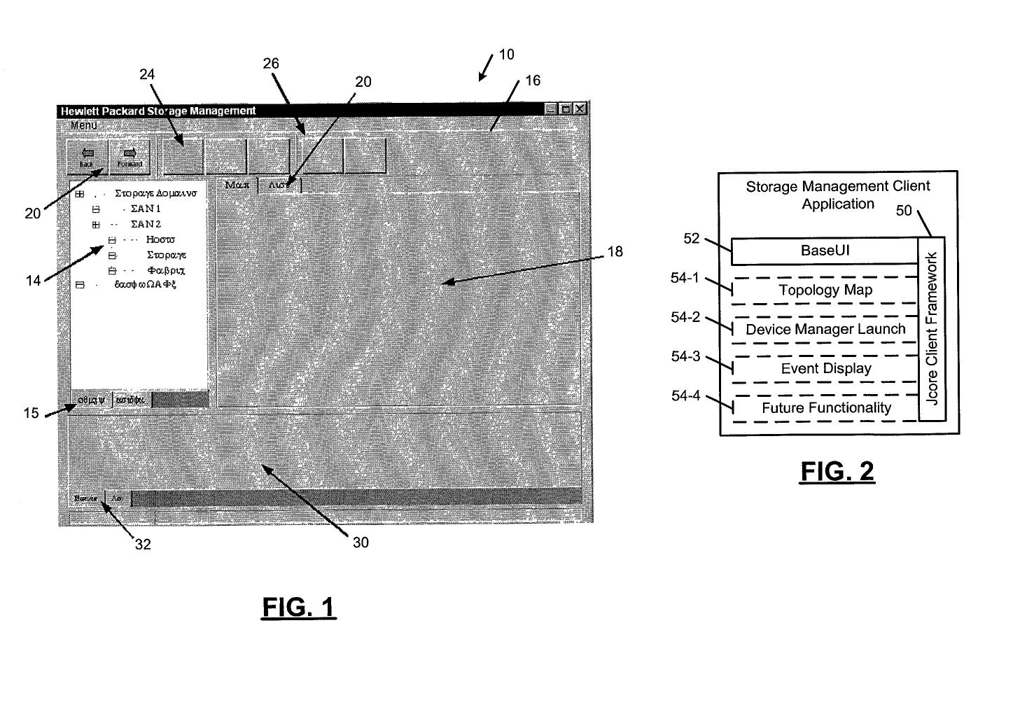

Referring now to FIG. 1, a user interface (UI) framework according to the present invention provides a platform for building Java applications with a browser-style graphical user interface (GUI) 10. The UI framework allows independent software components to be integrated into a single GUI-based application. Each component can optionally provide UI elements to the application and may also extend the elements of other components through integration.

The browser-style GUI 10 includes a hierarchy of objects in a tree list 14 on the one side of a main window 16. Alternate versions of the tree list 14 may be selected using tabs 15. A view panel 18 of a currently selected tree object is presented on the other side of the main window 16. The view panel 18 may be adjusted using tabs 20. Additionally, browser-style navigation is provided with back/forward buttons 20. Context dependent and independent buttons 24 and 26 are also provided. A log panel 30 provides a “log” type displays such as events. A tab 32 allows adjustment of the information displayed in the log panel 30.

The UI framework is a Java class library that supports the browser GUI 10 by providing a set of tools built on Java Swing components. While the present invention will be described in conjunction with storage management applications for storage area networks (SANs), skilled artisans will appreciated that the present invention is not limited to SANs. The UI framework meets the specific needs of both Storage Node Manager (SNM) and Storage Area Manager (SAM) products that are available from Hewlett Packard Co. However, the UI framework does not require SNM and SAM components to be present. In other words, they are not a core part of the UI framework. These components could be present in product deployments that require their respective functionality. The UI framework can be used with other types of products that do not have SNM or SAM functionality.

The present invention is described as a software-based UI framework. The term “framework” has different meanings in different contexts. The UI framework is intended to be used for applications that are integrated into larger enterprise management frameworks such as CA Unicenter, OpenView, or Tivoli. The UI framework integrates the functionality of multiple applications into a single client application. The design favors, but does not require, a reasonably tight integration of visual elements. (e.g. different products can add items to the same menus, tree views, etc.)

The UI framework builds upon functionality provided by a Java Core framework (Java core). Java core is a Java class library that facilitates the development of distributed applications. Java core provides a standard framework for the development of application functionality that is “plugged-in” to a distributed application. Java core enables application features to be built into modular components that can be quickly packaged together. Furthermore, client applications are automatically updated with new or enhanced components without user intervention. Java core standardizes and structures the use of several key technologies that are integrated into the UI framework. Developers do not need to worry about the idiosyncrasies and pitfalls of technologies such as Java RMI, Java dynamic class loading, and spontaneous networking.

Java core provides two major benefits to the UI framework. First, it makes it much easier to develop and deploy complex, secure, and distributed Java applications. The UI framework does not require any of this functionality in Java core directly. Many applications of the UI framework provide functionality that relies on Java core.

Second, Java core provides a simple framework for building client applications from separate components. Individual components are added and removed from applications easily with no coding impact on other components. The UI framework relies on this aspect of Java core to implement many of its integration features. Another peripheral benefit that the UI framework receives from Java core is the automatic client component update features.

### UI Framework

The present invention will be described in conjunction with an exemplary implementation that relates to storage networks. Various components can be organized into an application that serves as a merged SNM/SAM platform. Skilled artisans will appreciate that the following description is an exemplary implementation for a specific product deployment using the UI framework. Some of the components that are identified below are not part of the UI framework.

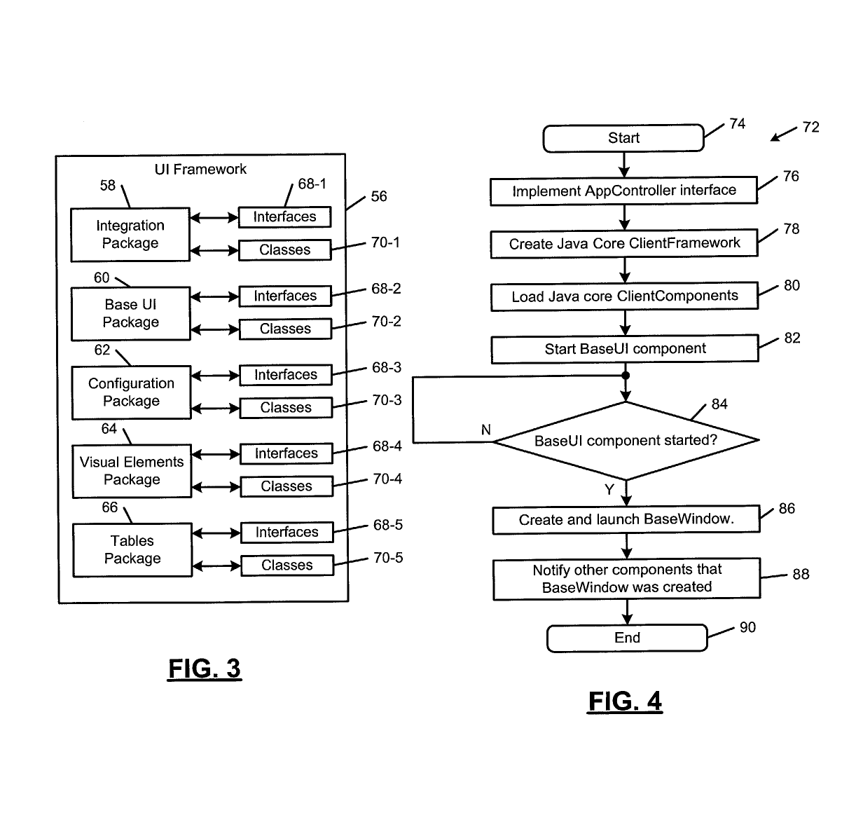

Referring now to FIG. 2, a client application is part of the UI framework. The UI framework includes a Java core client framework 50 with a BaseUI component 52 and other Java core components 54. The BaseUI component 52 and the Java core client framework 50 are preferably included in the UI framework. The components shown in dashed lines are optional and generally independent (although some components may have dependencies on others).

The BaseUI component 52 of the UI framework is a Java core component that provides the base application window 16 of FIG. 1 and a set of common UI services. The UI services include navigation, general configuration, toolbars, menu bars, help, and other GUI functionality such as depicted in FIG. 1. The BaseUI component 52 does not provide any functionality specific to storage management—it is an empty shell. The other Java core components 54 that are part of the client framework plug into the BaseUI component 52 and provide specific product functions and visual content. Multiple products can share the base application panels such as the view panels, log panels, etc. or alternately launch another tool with windows of the product.

The BaseUI component 52 provides the main window 16 for the application. The main window is a browser-style window with the navigation tree 14 and the panel 18 for displaying contents of the current object selected in the tree 14. An additional log panel 30 at the bottom provides an area for “log” type displays, such as events. The browser paradigm was chosen for the base application for the UI framework because it can be adapted to display a diverse range of information. Browsers such as Windows® and Explorer® are widely used and well understood.

The UI functions currently provided by SNM components can be implemented with a set of Java core components that integrate with the BaseUI. In this embodiment, SNM functionality includes topology maps, event display, and device management launch.

### Architecture

The architecture of the UI framework includes a client application that contains a Java core client framework. The client framework connects to a storage management server that provides the data models for the UI components. The framework includes the BaseUI component 52 and several additional client UI components 54.

The BaseUI component 52 provides basic navigation of objects presented in the navigation tree and view panels. The BaseUI component 52 enables components to integrate popup menu items into tree and view panel objects. The BaseUI component 52 enables buttons to be added into the tool bar and menus to be added to the menu bar. The BaseUI component 52 enables components to display items in the log panel area and in the status bar area. Currently the status bar area is limited to a client-server connection status indicator, a progress indicator associated with the loading of the currently displayed panel, a process indicator that can be used to indicate that a process is currently busy or idle, and a contributor icon that will indicate which component supplied the currently displayed panel.

One of the basic services provided by the BaseUI component 52 is navigation of items selected by the user. The navigation tree, navigation controls, and view panel areas of the main application frame are the visual components that handle navigation. The BaseUI component 52 maintains one or more hierarchies of NavObject objects. A NavObject is a class that represents an association between objects in a data model and a visual component that can be selected by the user.

All nodes in the navigation tree component represent a NavObject. The BaseUI component 52 does not create any NavObject objects directly—all NavObject objects in the application are passed to the BaseUI component 52 by other Java core client components 54. The underlying model for a NavObject can be any object. In most cases it will be an object in the storage management data model—e.g. a host or storage device. The model for a NavObject can also be a list of other NavObject items—e.g. one can represent the aggregate of all hosts in a storage domain, so that there can be a hosts node in the tree.

The view panel area of the application frame contains a visual component corresponding to the currently selected NavObject. Every NavObject implementation has a factory method that provides one or more panels. If there is only one panel, the panel is displayed directly in the view panel area. If there is more than one panel, the panels are displayed as a tabbed pane. In addition, other components can add panels to a NavObject display by registering as a ViewPanelContributor.

NavObject objects are preferably organized hierarchically and presented in the navigation tree panel. There can be multiple NavObject trees in an application, each representing a separate context. Contexts can be used to distinguish between perspectives of the similar NavObject hierarchies. For example, SAN components can be presented in a topology context, where each node in the tree represents a component in the topology. Another context could present the same devices in an “inventory” hierarchy, where folders represent groups of similar objects such as host, switches, etc. Contexts can be selected by the user with the navigation context tabs in the navigation tree panel.

When a NavObject is selected, the BaseUI component 52 creates view panels for the object. Every NavObject implementation must provide at least one view panel. If there is more than one view panel, the view panels are displayed in the view panel area as tabbed panels. The BaseUI component 52 creates the view panels in two steps. First, the BaseUI component 52 calls a method in the NavObject that returns the base view panels defined for the object. Second, the BaseUI component 52 calls a method in all UI components that have registered as a ViewPanelContributor for the instance of the NavObject selected.

Each NavObject implementation provides a set of base tabs. For example, a general storage device NavObject provides a panel that shows a graph of utilization and another that shows a list of LUNs. UI components add tabs to a specific NavObject by registering as a ViewPanelContributor and providing additional tabs. For example, a performance monitoring component registers to provide additional tabs to storage devices for which it has performance information.

A view panel is preferably a Java JPanel object. In order to accommodate hyperlink style navigation through the contents of the view panel, the BaseUI component 52 provides a set of visual objects to represent a NavObject. These objects are selected for navigation and “right-clicked” to display the context sensitive or “popup” menu for the NavObject.

An example of a component that can be used to represent a NavObject is the NavObjectLabel class. This is a basic label that displays the name and icon of a NavObject. When clicked, the NavObjectLabel sends a message to the BaseUI component 52 to select the associated NavObject. Developers implementing the view panel use the NavObjectLabel to link contents of the panel to a NavObject. The BaseUI component 52 handles the specific navigation functions. In addition to the NavObjectLabel, there are table and list components that provide navigation facilities.

NavObjects have a context sensitive popup menu. The default menu items include basic navigation operations like “open” and “open in new window.” In addition, UI components can register as a PopupContributor for a NavObject to add custom menu items. When a visual component for a NavObject is selected with the right mouse button, the BaseUI component 52 creates a popup menu including default items and all the items contributed by registered PopupContributor objects.

The most basic form of integration of UI components into the BaseUI component is provided through tool buttons and menu items. The BaseUI component provides an interface that allows other components to add buttons to the toolbar and menu items to specific menus. When one of these buttons/menus is selected, the BaseUI component 52 sends a message to the associated component. This component can do anything in response, including opening its own windows.

There are two toolbars in the toolbar area in the application frame. Components can add buttons to either. One toolbar is for actions in the context of the currently selected NavObject, the other is for actions that do not require any context. The BaseUI component 52 provides some default tool buttons on both toolbars.

The context-independent tool buttons allow a basic launch capability for functions that cannot be provided through tighter integration methods provided by the BaseUI component 52. This can be used as a bare-minimum integration of external tools.

The bottom portion of the main application frame includes the log panel 30. The log panel 30 is intended for any custom displays that a UI component wants to place on the main window. Examples include event lists or output logs. When the UI components want to send data to the log panel 30, the UI component calls a method in the BaseUI component 52 and passes a Swing JPanel as a parameter. The UI component is responsible for handling all events on objects in the panel. If multiple components register a log panel with the BaseUI component, the tabbed pane 32 is used to allow the user to select a desired log panel.

The UI framework provides facilities for customization and configuration. This includes a global configuration database and an API that allows component developers to access configuration parameters.

### Implementation of Storage Node Manager Functions

This section describes the specific components that integrate SNM functionality into the client application. Three separate Java core client components provide the respective functions of topology maps 54-1, device management launch 54-2, and event display 54-3.

The topology map component 54-1 presents maps of interconnected elements in a storage domain. The topology map component 54-1 creates a hierarchy of NavObject objects that correspond to the navigation tree in SNM. These are added to a “topology” context in the BaseUI component 52. The view panel for each object is a Swing component that renders the corresponding map. The icons in the topology map panels are Swing components that fire navigation and selection events to notify the BaseUI component 52 of user activity. The BaseUI component 52 handles popup and drill-down selections through its navigation facilities.

Map presentation options including zooming and panning are provided through tool bar and menu contributions. In addition to maps, a second view panel tab is provided. The second view panel tab presents a table of relevant information for the selection. This may include an inventory for storage domain view panels or a list of specific device information for device view panels.

The device management component 54-2 launches a device manager (including the launch of a web browser if necessary). Device manager launch occurs through the use of popup menus (and/or a toolbar button and main menu item). The device manager component 54-2 registers as a PopupContributor for all NavObject items for which it has a device manager. The UI framework simply notifies the device manager component 54-2 when one of these items is selected.

The event display component 54-3 includes a table of recent events and an event browser utility. The event display component 54-3′ registers a log panel in the BaseUI component 52. The log panel provides the recent event list. The full-featured event browser utility is integrated via a tool button and menu item.

### UI Framework Details

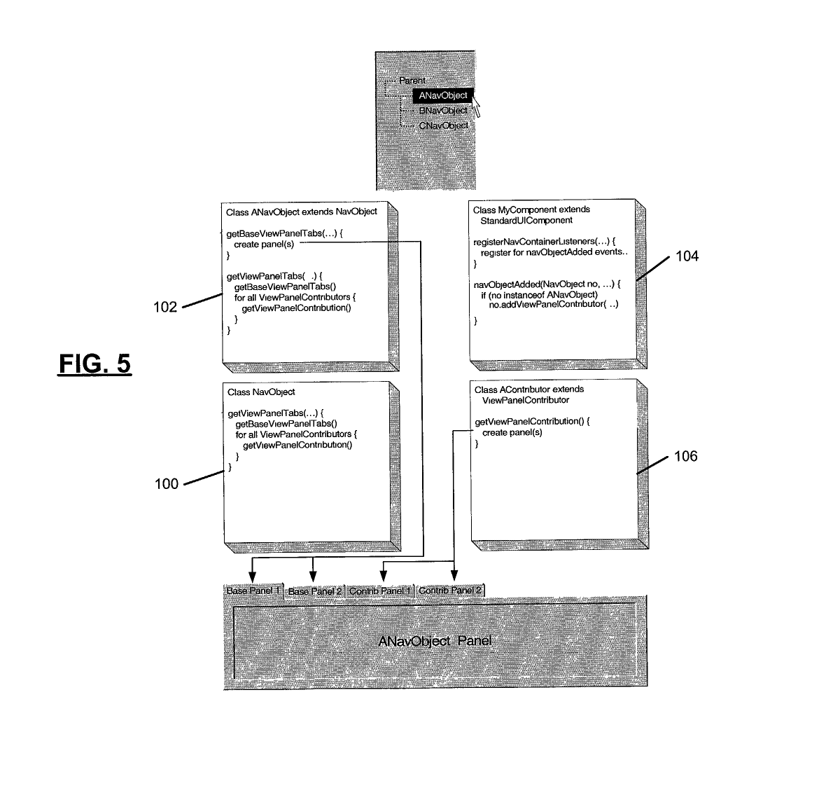

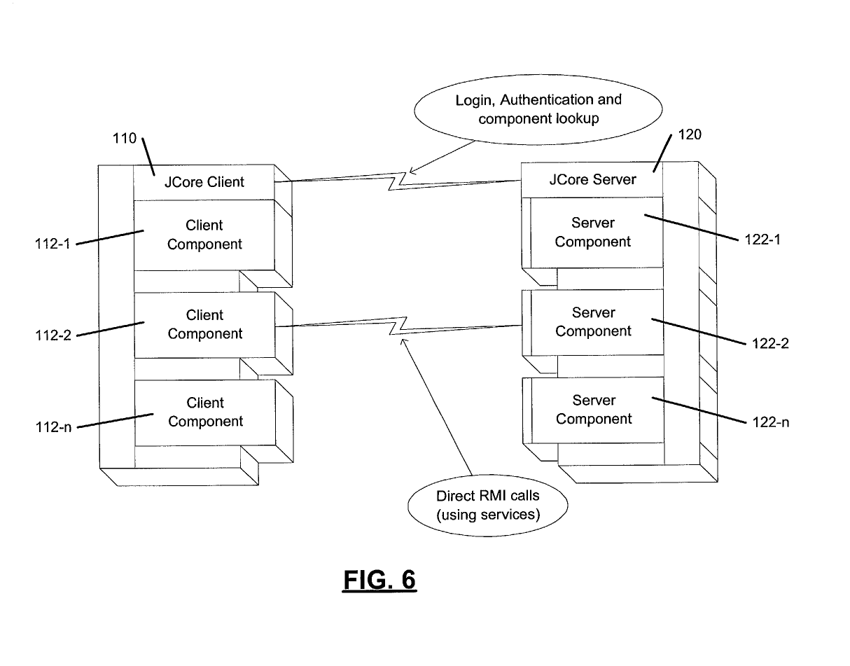

Referring now to FIG. 3, the UI framework 56 is implemented by a plurality of Java packages. All classes are contained within 5 Java packages: an integration or phluid package 58, a BaseUI or phluid.base package 60, a configuration or phluid.config package 62, a visual element or phluid.widget package 64, and a tables or phluid.widget.table package 66. The packages 58-66 contain classes 68-1, 68-2, . . . , and 68-n and/or interfaces 70-1, 70-2, . . . , and 70-n. As can be appreciated, fewer or additional packages may be used.

### Phluid Package

The phluid package 58 is the UI framework package that defines the core classes used for integration. The classes in the phluid package 58 are not visible UI elements—they are used to define standard objects and the interfaces used to access the underlying data structures of the UI framework.

### Phluid Package—Interfaces

The phluid package 58 includes the following interfaces 68-1: AppController is an interface for classes that control the behavior of a main application. BaseUI is an interface for applications that implement an application platform. Application components use this interface to integrate their GUI components into the main application. Config is an interface for access to general configuration information. Configuration parameters are properties organized hierarchically. Each child level is called a sub-config. Levels are delimited by a dot in the string representing the name.

MenuBarContributor is an interface for objects that contribute menus and menu items to the menu bar of application windows. MenuContainer is an interface that defines a “container” for menus. Note that this is not a visible component and is not related to the java.awt.Container or the java.awt.MenuContainer classes. A menu container contains the following standard menus: File menu, Edit menu, View menu, Tools menu and Help menu.

NavContainer is an interface that defines a “container” for navigation items. A container includes a set of navigation contexts (a hierarchy of NavObjects). Note that this is not a visible component and is not related to the java.awt.Container class. NavContainerListener is an interface for objects interested in changes (adds/deletes) to the NavContainer. NavContainerNotifier is an interface for classes that post events when the contents of a NavContainer changes. NavObjectFilter is an interface for classes that wish to distinguish between different types of NavObjects. NavObjectSelectionListener is an interface for classes interested in receiving notification that a user has selected a NavObject for viewing.

NavSelector is an interface for classes that control the selection of NavObjects for navigation. NavTreeEventListener is an interface for objects interested in knowing about NavTree events, such as expanding/collapsing of tree nodes, and keyboard events. PopupContributor is an interface for objects that add items to the popup menu for a NavObject. ProgressIndicator is an interface for classes used to display progress, such as a status bar. ToolContributor is an interface for objects that contribute tools and toolbars to application windows. ToolGroupContainer is an interface that defines a “container” for a ToolGroup. Note that is not a visible component and not related to the java.awt.Container class.

ViewPanelContributor is an interface for objects that add tabs to a NavObject view panel. WindowCreatedListener is an interface for objects interested in the instance creation of a BaseWindow or ChildWindow.

### Phluid Package—Classes

The phluid package 58 includes the following classes 70-1: CachedViewPanelTab is an abstract view panel derivative that provides a facility to cache its view panel instances as they are created to save time when switching between NavObjects. EventMap defines events used by the framework for the component bootstrap sequence. Components that extend the StandardUIComponent class do not need to use this directly. NavContext is a class that defines a context for a group of NavObjects. A context is hierarchical and can contain multiple roots.

NavObjects is a context that can be flagged as primary or secondary. Secondary objects exist in the hierarchy but will not be considered by the TreeModel interface methods that this class implements. Therefore, secondary objects will not appear in any JTrees. NavObject is a class for objects that can be navigated by user actions. Note that a NavObject is not a visible component. This class creates an association between a data model and its visible UI components. This class implements Comparable so that representations of NavObjects can be easily sorted in tables, etc. NavObjectSelectionEvent is an event indicating a NavObject has been selected. NavObjectTreeNode maintains parent-child links in the tree hierarchy of a NavContext. Resource is used to manage UI resources. This class is almost identical to the standard Java ResourceBundle, except that it provides an additional method that allows the location of images to be specified in the resource bundle.

StandardUIComponent is an base class for Java core client components that have UI elements. This is provided as a convenience to developers. This class handles the details of the UI component bootstrap sequence. It is recommended that application client components extend this class.

ToolGroup is an panel that displays a group of JComponents in the fashion of tool bar. This is named a “group” instead of “toolbar” so that it is not confused with Java Swing's JToolBar. ViewPanelTab is an class that defines a tab to be displayed in the view panel for a NavObject.

### Package phluid.base

The phluid.base package 60 provides the actual implementation of the BaseUI interface and all supporting classes. Most of the classes are specific to the framework implementation and are not generally useful to application component developers.

### Package phluid.base—Interfaces

The phluid.base package 60 includes the following interfaces 68-2: ConnectionStatusListener is an interface for classes interested in receiving notification about the current state of connectivity between the client and server applications. NavWindow is an interface for any window that has it's own navigation state. ProcessBusyStatusListener is an interface for classes interested in receiving notification that a process status has changed to either busy or idle. ViewPanelContributorIndicator is an interface for classes that need to display contributor information about the currently displayed view panel (such as in a status bar).

### Package phluid.base—Classes

The phluid.base package 60 includes the following classes 70-2: AboutDialog is a JDialog that knows how to display version information for all loaded Java core ClientComponents. AppWindow is a basic window suitable for use as the main application window. BaseUIComponent is a Java core client component that provides a BaseUI interface. This is only the Java core component. The class that actually implements the BaseUI interface is StandardBaseUI. BaseWindow is a base window of the application. Only one of these will exist for the application. ChildWindow is a window that displays a NavObject separately from the main applications BaseWindow.

ContentPanel displays the view panels of the currently selected NavObject. LogPanel is a JPanel used to hold log information at the bottom of the BaseWindow. LogPanelTab is a tab panel within the LogPanel. MainMenuBar is a JMenuBar that is created for each application window. MainMenuBarKeyListener is a KeyAdapter that listens for keyboard events in the MainMenuBar.

NavButtons is a ToolGroup that displays back/forward/up navigation buttons. NavPanel is a JPanel that contains the NavTree. SelectionPoster is used to fire selection events from the Swing thread. StandardBaseUI is a standard implementation of the BaseUI interface. StandardNavSelector is a standard implementation of the NavSelector interface that keeps a history of all selections to ensure that there is always a selected context and a selected NavObject in each context (unless all contexts are empty).

StatusBar is the status bar associated with an application window. ToolPanel is a JPanel that contains all tool bar items. VeiwMenu—a JMenu that deals with navigation functions, such as forward, back, up, etc. It also keeps a history log.

### Package phluid.config

The phluid.config package 62 defines implementations of the phluid.Config interface.

### Package phluid.config—Classes

The phluid.config package 62 includes the following class 70-3: LocalPropertyDBConfig implements the phluid.Config interface which can handle Java core PropertyDB objects.

### Package phluid.widget

The phluid.widget package 64 is the root package for visual elements and supports classes that can be used to develop UI content.

### Package phluid.widget—Interfaces

The phluid.widget package 64 includes the following interfaces 68-4: ProcessBusyIndicator is an interface for classes that need to display contributor information about any process that may currently be in a busy state (such as in a status bar). StatusBarContributorIcon is an interface for classes that implement view panels. This interface will allow the class to display who is contributing the content of the view panel (such as in a status bar). TableHeaderResizedListener is a listener that is notified whenever a table column header is resized. ToggleBoxSelectionListener is a listener that is notified whenever a ToggleBox state changes.

### Package phluid.widget—Classes

The phluid.widget package 64 includes the following classes 70-4: BaseDialog is an extension of javax.swing.JDialog that provides some convenience methods and/or controls to simplify standard dialog creation. BrowserLauncher is a class that encapsulates the opening of a default web browser for a given URL. CheckBoxBox is a swing component that groups multiple JCheckBox components. The buttons are arranged vertically. CheckListPanel is a helper class to implement a JList with checkboxes inside a JScrollPane. ChooserPanel is a helper class that implements a standard “chooser” dialog, where there are 2 lists of items: a list of available items to select from, and a list of selected items. The items in these 2 lists can be moved back and forth between the 2 lists.

ControlButton defines standard control buttons. Cursors defines standard cursors, such as the cursor used when mouse is hovered over a NavObject. FormCancel is a Java key adapter that recognizes ESC key-press as a dialog cancellation action. FormColumn is a JPanel convenience wrapper, useful for building forms and dialog boxes. FormField is a widget useful for placing text fields into forms. FormLabel is a convenience JLabel wrapper that is useful for placing sized labels in forms. FormRow is a JPanel convenience wrapper that is useful for building forms and dialog boxes.

|18nOptionPane is an internationalized wrapper for JOptionPane.showMessageDialog( ) and JOptionPane.showConfirmDialog( ). NavObjectImageMap is an “image map” that associates regions of an image with NavObjects. Mouse events over the specified regions trigger appropriate actions (e.g. selections, popup menus). NavObjectLabel is a basic component for display of a NavObject that handles cursor change on mouse hover, selections, and popup menus.

NavObjectTable is a sortable table with various customizations for displaying cell data. This includes support for columns that contain NavObjects, columns that have a TableCellMap, and filtered data using the FilteredTableModeL NavTree is an extension of JTree that can be used to display a NavContext. The nodes of the tree are instances of NavObjectTreeNodes.

NoFocusTextArea creates a non-editable & non-FocusTraversible JTextArea. PropertyTable is a basic two column table useful for displaying name/value pairs. Note that this is not an extension of JTable. RadioButtonBox is a Swing component that groups multiple JRadioButton components, allowing only one to be selected at a time. The buttons are arranged vertically. ResizableLabel creates a resizable JLabel.

RolloverButton is a button that highlights when the mouse is over it. RolloverToggleButton is a toggle button that highlights when the mouse is over it. ShiftedIcon is an Icon that contains an offset value for customized placement. SmartPopupMenu is a JpopupMenu that automatically shifts its placement so that all of its contents are viewable (within the display bounds). Splash is a Utility class for creating application “splash” windows. StandardTable is a JTable that fires header resized events. SubtleBevelBorder is a border that is useful for highlighting buttons. SummaryPanel is a convenient class for displaying a table and a summary row of JPanels that resize with the table. SwingWorker is an abstract class that can be subclassed to perform GUI-related work in a dedicated thread.

SynchronizedTableHeaderPanel is a panel with containers having a size that is synchronized with the column size of the specified table. There is no containing relationship between the instance of this class and the specified table, only a size relationship. TableHeaderResizedEvent is a event that is fired when the user resizes a table column header. ToggleBox is a swing component that organizes multiple JToggleButton components in a horizontal row or vertical column. Methods are provided to control and query the state of the buttons. An attribute controls whether multiple selections are allowed. ToggleBoxSelectionEvent is an event used to indicate a state change in a ToggleBox. ToolBarButton is a basic button for use in ToolGroups.

UpDownButton is a JPanel that simulates an up/down button and is usually associated with a text field that displays a number value. Pressing the up/down button changes the text field accordingly. URLLinkedLabel is a simple extension of JLabel that will launch a browser with a certain URL when clicked with the mouse. WholeNumberField is a JTextField that only accepts whole number values.

### Package phluid.widget.table

The phluid.widget.table package 66 contains widgets specifically related to tables.

### Package phluid.widget.table—Interfaces

The phluid.widget.table package 66 includes the following interface 68-5: TableCellMap maps table cells to UI components.

### Package phluid.widget.table—Classes

The phluid.widget.table package 66 includes the following classes 70-5: BooleanFilterOperation is used in determining if a row should be added to a table. ChainedTableModelFilter is used to determine whether a row should be added to a table. ColumnValueFilterExpression is used to determine whether a row should be added to a table. DefaultSummarizer is a class that returns the double value for the Java primitive data type wrappers.

DefaultSummaryTableModel is a default table model for associating with a JTable. This provides a solid implementation of the abstract SummaryTableModel. DefaultTableCellMap maps table cells to some value. FilteredTableModel used in determining if a row should be added to a table. MultiFilteredTabelModel is used in determining if a row should be added to a table. NavObjectTableCell is a table cell for NavObjects. Implements Comparable and will sort NavObjects based on the String returned from NavObject.getName( ). SortableTableModel is a table model that provides a method to sort rows. Each row is an instance of the inner class TableRow. Each element in the table must implement the Comparable interface. SummaryTableModel is a table model that is sortable and summarizable. Summarization functionality includes sum, averages, etc.

TableModelFilter provides a filtering mechanism to limit what is displayed in a table. TableModelFilterParseException is an exception thrown by the TableModelFilter.

### Integration Guidelines

The main application that is built upon the UI framework implements a method 72 that begins in step 74. In step 76, the AppController interface is implemented. In step 76, a Java core ClientFramework is created. In step 78, Java core ClientComponents are loaded. In step 80, the BaseUI component 52 is started. Once the BaseUI component 52 is started, the BaseUI component creates and shows the BaseWindow in step 86 and notifies interested listeners that the window has been created in step 88.

All contributing components provide a UI class that extends the StandardUIComponent. This automatically registers the component as a Java core ClientComponent. As a StandardUIComponent, the contributing component implements several interfaces. Initialize( . . . ) is called by Java core when the component is loaded. RegisterNavContainerListeners( . . . ) is called by the BaseUI component 52 so that the component can register as a NavContainerListener. RegisterUI( . . . ) is called by the BaseUI component 52 so that the component can register any UI contributors (eg. for the tool bar, menu bar, etc.)

Contributing components may also register as a factory creator of specific NavObjects. This means that if the NavObject type is ever requested and it doesn't yet exist, this component will be responsible for creating it.

The primary purpose of tool button and menu integration facilities is to integrate functions that do not fit into other integration methods. Appropriate functions for tool buttons and menus include tools that require complex, specialized dialog boxes (e.g. Wizards). Launch of third-party or other applications that cannot be integrated in any other way and short-cut methods to activate or perform contributing functions are also appropriate.

Component implementations for adding menus to the main menu bar need to perform several tasks. The component implements the MenuBarContributor interface and registers as a MenuBar contributor. As a registered MenuBar contributor, the component is able to contribute both menus and menu items when the main menu bar is initially created for a newly created application window. Menu items can be added to any existing base menus that were already contributed (i.e. the base menus “File”, “View”, “Tools”, etc.). Methods are available to add the items either relatively (i.e. next available slot) or absolutely (i.e. in first slot). Accelerators and action listeners can also be defined. Once the menu item is selected by the user, all registered action listeners will be notified.

Component implementations for adding tools to the toolbars need to perform several tasks. The components implement the ToolContributor interface and register as a Tool contributor. As a registered Tool contributor, the component is able to contribute both tool groups and individual tools to already contributed tool groups when the main tool bar is initially created for a newly created application window. Action listeners can also be defined. Once the tool button is selected by the user, all registered action listeners are notified.

Component implementations for adding popup menus to NavObjects need to perform several tasks. The components implement the NavContainerListener interface and implement the PopupContributor interface. When informed that a NavObject has been created (via the NavContainerListener interface), the component registers with the NavObject as a PopupContributor. As a registered PopupContributor, the component is notified when the NavObject has been right-mouse selected. The contributor at this point can add any additional popup menu items and register the associated action listeners. If a popup menu item is selected by the user, all registered action listeners are notified.

In general, the number of navigation contexts should be kept to a minimum. The tree for each context can have several roots. Preferably, another root is added to an existing context instead of creating an entirely new context. The integration point for adding and removing NavTree objects is via the NavContainer, which is always available through the BaseUI component. The specific methods are: AddToNav(String contextName, NavObject parent, NavObject child, boolean secondary) where: ContextName relates to the NavContext of the NavTree. Parent is the node that will be the parent of the new node. If null, the new node is at root. Child is the new node to add. Secondary is true means the child and children of the child will not be shown. AddToNav(String contextName, NavObject parent, NavObject child, boolean secondary, int priority) where: priority is can be used to sort objects based on priority (will not use the Comparable interface). RemoveFromNav(String contextName, NavObject no, String reason) where: If a reason is passed, it will be displayed to the user when advised of deletion.

All NavTree objects must be NavObjects. NavObjects can be added at any level in the tree and will be represented by their associated icon (NavObject.getIcon( )) and name (NavObject.getName( )). All NavObjects implement the Comparable interface to ensure that they are sorted correctly. Also associated with each NavObject is a set of view panels that are displayed when the NavObject label is selected in the NavTree.

### View Panel Contents

Referring now to FIG. 5, providing useful content to the selected NavObject is typically where contributing components will spend most of their development time. In the NavObject class, there is a method called getViewPanelTabs( . . . ) 100. This method 100 accumulates all defined view panels for the specific NavObject class. This includes the panels created directly by the NavObject and any panels contributed by other components.

There are at least two ways for a component to create view panels for a NavObject. First, extend the NavObject class. When the NavObject class is extended, the method getBaseViewPanelTabs( . . . ) as depicted at 102 is implemented. It is here that the component can create and return view panels. Second, register as a view panel contributor for a specific NavObject. Typically, this is accomplished by registering as a NavContainerListener as depicted at 104 When the specific NavObject is created (added), the contributor adds itself as a ViewPanelContributor via the NavObject method addViewPanelContributor( . . . ) as depicted at 106.

When creating view panels, the CachedViewPanelTab class is extended. This class provides a facility to cache the view panel instances as they are created to save time when switching between NavObjects.

### Log Panels

A log panel is automatically created when the BaseWindow is created. By default, this panel is empty. To add content to the log panel, contributors create a JComponent and add it via the BaseUI method addLogPanel( . . . ). This is done at initialization of the contributing component, typically in the registerUI( . . . ) method. Once the log panel is added, BaseWindow retrieves all contributing panels from BaseUI when it is created.

While drag and drop functions in the main application frame are not currently supported, these functions are contemplated. In addition, panel contributors are free to provide this functionality. For example, if a component provides a graphic map of storage devices on a panel, it may be desirable to allow the user to drag and drop nodes on each other to indicate connectivity.

It may be useful to constrain navigation tree hierarchies so that a particular instance of a NavObject only appears once in the tree. For example LUN objects are children of the storage device that contains them, then LUNs will not appear under hosts also. The host LUNs can (and should) be listed in the view panel for hosts and selected from there. This constraint will allow a more predictable implementation of an “up” function in navigation, where “up” means select the parent of the currently selected object. By requiring the hierarchy to be a true tree structure, the parent of a particular object is not ambiguous. The downside of this requirement is simply that it limits the ways that objects can be organized in the tree.

### Java Core

Java core provides an extensible framework for building distributed Java applications that are structured around Java's Remote Method Invocation (RMI) standard as a primary remote procedure call (RPC) mechanism. Java core enables a component-based application architecture by providing the infrastructure for the following component related features: Dynamic component loading that enables extensible applications that determine their scope of functionality at runtime. Component brokering and lookup that allows components to use each other's services. Automatic update and downloading of components allows self-updating of client/server relationships as well as just-in-time component delivery.

Java core provides spontaneous networking services. Service providers and service consumers dynamically find each other based on attributes rather than network addresses. Java core provides a single point of enforcement for authentication and security services that provide a trusted environment for developers of product functionality. Java core also provides a basic set of infrastructure services including a distributed events system (publish/subscribe across distributed components), logging and tracing facilities, remote access to hierarchical property databases (similar to Windows registry, but in a platform independent fashion), leasing services with connection “health” monitoring, and an extensible command-line interface component. Java core allows remote launching of processes with return of the standard output and standard error streams. Java core supports remote task and event scheduling and distributed locking and arbitration services.

Java's RMI technology has been chosen as the primary RPC mechanism. RMI enables a distributed, object-oriented model of programming that enhances developer productivity. RMI enables remote objects to behave polymorphically and hides implementations from the clients. It also enables a natural programming syntax supporting normal parameter passing and method invocation that is virtually indistinguishable from non-distributed object oriented programming.

Java core standardizes the use of RMI as the primary mechanism for communication between distributed components. Java core also relies on standard RMI semantics and does not require custom compilers for objects that export remote interfaces (beyond the traditional use of the RMI compiler). All normal use models of RMI are acceptable. For example, custom socket factories and the specification of custom codebase URLs for dynamic download of stubs or other client-side code are available.

Java's dynamic class loading technology allows the extension of program features at runtime, without reboots, recompiles or restarts. Java core creates a framework to standardize the use of dynamic class loading and to provide a number of services to maximize the value of this technology. Furthermore, this technology enables new features to be plugged into an existing application installation with minimal impact on the system.

Java core enables the building of applications that are collections of components. The intention is to focus developer effort on product functionality, and to gather “application overhead” into a shared infrastructure that is built only once. Java core also enables the rapid development of custom applications that are built by “mixing and matching” preexisting components to deliver the desired functionality.

Java core components resemble traditional Java applications in that they are not constrained in what they can do. They can create GUIs, and perform console input and output. However there are significant differences. Java core components do not implement a main( ) method. Instead Java core components implement a class that extends a Java core base component class. In this class, Java core components override a method called initialize( ). This method is the equivalent of an application's main( ). In this method, a component may create additional objects or start threads as necessary to perform the job of the component.

An entry is made in a component database (DB) file that will cause the component to be dynamically loaded. This can be accomplished by simply “dropping in” a file with the right information and naming convention into the appropriate directory.

Components are passed a Component Manager object in the initialize method. This object can be used by the component to obtain references to other “peer” components or to remote server components. Components are also passed a property tree that can be used to configure the behavior of the component much like a command-line argument would be used to configure the behavior of an application.

Referring now to FIG. 5, a Java core client 110 includes a plurality of client components 112-1, 112-2, . . . , and 112-n. The UI framework of the present invention employs the Java core client and client component structure. A Java core server 120 can optionally be provided and includes a plurality of server components 122-1, 122-2, . . . , and 122-n. If provided, the client components 112 make direct RMI calls using services.

Java core provides a broad set of services related to components. These services include dynamic loading of components at program startup. New components can be added to an application by simply “dropping in” the appropriate files in the appropriate locations. There is no need to modify the CLASSPATH or other environment variables to make the component accessible. The order that components are loaded and started can be controlled. Thus if a component has dependencies on other components, the loading of the components can be controlled.

Component brokering and lookup enables client components 112 to use each other's services. Client components 112 may access and use other local client components (“peers”), as well as the remote interfaces exported by client components on a remote server (not shown). Because this brokering is performed within the trusted environment created by the framework's login and authentication responsibilities, the client components 62 may use other client component services securely.

Automatic update and downloading of components allows self-updating client/server relationships as well as just-in-time component delivery. For example, this allows new features to automatically appear on remote GUI clients after a new version of a central management server has been installed. This becomes an important feature in large distributed installations where many clients have been deployed. When a new release of the software is installed on a central location, all of the dependent clients are updated as necessary. Java core provides a number of features to control this behavior, so that different components can be downloaded to different types of clients based on “group names” and version tags.

Software applications in a distributed (networked) environment can be thought of as either service providers or service consumers, or both. Service providers are programs that provide interfaces that other programs can use to perform a task. The programs that use these interfaces are the service consumers. Many distributed software applications accomplish their objectives by utilizing many software services distributed throughout the network.

In the past, most applications that used distributed services required pre-configuration of the locations of the service providers that supplied the particular service. For example, an application needs to be configured to know a network address of a printer for printing. Similarly, a GUI front-end to a database needs to be configured to know a location of a computer hosting the database.

The objective of the Java core service discovery technology is to avoid having to pre-configure the applications with the network addresses of desired services. Instead, applications dynamically discover the services that are needed. Services are identified by a set of attributes that describe the type and quality of service that they is provided (the actual location becomes irrelevant).

The Java core service discovery technology provides a mechanism that allows software service consumers to locate the desired service providers. The services are discovered based on the attributes of the service rather than on the location (network address or URL) of the service. Although there are many existing solutions to this problem, they all suffer from a number of shortcomings. For example, directory services such as LDAP or CORBA object request brokers, require that the service consumer know the address of the directory service or object request broker. Furthermore, these services are extremely large services that are unwieldy in small distributed applications.

The Java core service discovery technology does not incorporate the concept of a third party lookup service. Instead services are discovered directly. The mechanism for discovering services involves the use of an IP multicast protocol with senders and receivers to discover and respond.

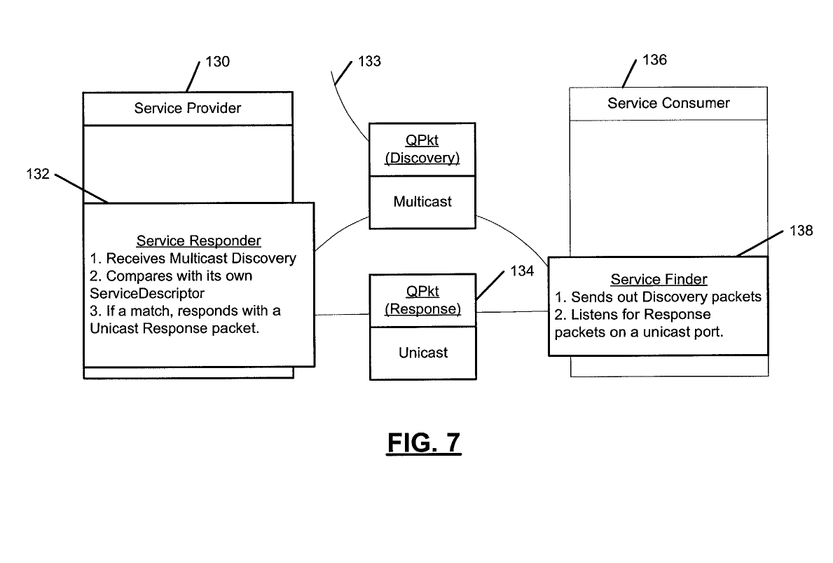

Referring now to FIG. 7, a service provider 130 includes a service responder 132 that receives a multicast discovery packet 133. The multicast discovery packet 133 contains a service descriptor. The service responder 132 compares the service descriptor in the discovery packet 133 with a service descriptor of the service provider 130. If a match occurs, the service responder 132 sends a unicast packet 134 to a service consumer 136 that includes a service finder 138 that sent the discovery packet 133. The service consumer 136 listens for a response on a unicast port.

The Java core discovery protocol includes the service descriptor that is an object that describes a service as a set of attributes. Attributes are completely user defined, consisting of name/value pairs. A service always has a service descriptor. Service descriptors are used in the discovery process to identify desired services.

The service finder is an object that is used by service consumers 136 to discover the service providers 138. The service consumer 136 submits a request to the service finder 138. The request also includes a service descriptor that describes the desired service. The service finder 138 sends out discovery packets 133 that contain the service descriptor describing the desired service. The discovery packets 133 are sent out using a standard IP multicast protocol. When responses are received from the matching service providers 80, proxy objects that are returned by the service providers 130 are passed on to the requesting service consumer 136. The service consumer 136 selects one of the proxy objects to use the services of the service provider 130.

The service responder 132 is an object that listens passively for discovery packets 133 sent out by the service finder 138. Service providers 130 create an instance of a service responder. When discovery packets arrive, the service responder 132 compares it against its own services. If there is a match, the service responder 132 responds to the sender of the discovery packet 133 with the proxy object for the services of the service responder 132.

There are no arbitrary points of failure. Services are either available or they're not. If the servers are available, the service responder responds directly to service consumers attempting to discover the services. If the service provider is not available, the service consumer will not discover the service provider. Only services that match the requesting discovery packets respond. The comparisons needed to discover one service from among hundreds or thousands are distributed across the network rather than concentrated in a single lookup service. Furthermore, discovering a service is not a two-step process (as in Jini where first you discover the lookup service, then you discover the service you actually want).

The service responder may, at its discretion, not respond to selected consumers. For example, the service responder 130 may not respond for security reasons. In this scenario, the requesting service consumer does not know that the services exist. Services are not advertised and are therefore more secure.

Java core provides a single point of enforcement for authentication and security services that enables a trusted environment for developers of product functionality. When a Java core client object logs in to a Java core server, an authentication process is followed that enables the server to authenticate the requesting client. The client authenticates the server it is calling. Once both parties are satisfied, access to the server's facilities and components is granted to the client.

Although Java core uses standard RMI semantics for inter-process communication, Java core does not use the RMI registry that is supplied with Java JDK for brokering of component remote interfaces. Instead, Java core provides its own internal component lookup and brokering services (coupled with the Java core Service Discovery technology discussed above). Remote interfaces are not visible to unauthorized applications attempting to access and potentially misuse distributed application component interfaces.

Because Java core uses standard RMI semantics, custom socket factories may be provided that may supply secure sockets for the RMI transport. Almost any Java secure socket implementation may be used with minimal effort. Java core also supplies a default secure socket implementation that can be used very easily.

Java core provides a number of additional services that are useful for developing distributed applications. These additional services are implemented as Java core components. A given application can choose a subset of services. The additional Java core services include: distributed events system (publish/subscribe across distributed components), logging and tracing facilities, remote access to hierarchical property databases (ala Windows registry, but in a platform independent fashion), leasing services with connection health monitoring, and extensible command-line interface component. Java core allows remote launching of processes with return of the standard output and standard error streams. Java core also supports remote task and event scheduling and distributed locking and arbitration services.

The UI framework of the present invention is an extensible platform that provides marketing flexibility, product quality, and developer efficiency. The component-based nature of the UI framework promotes the encapsulation of specific product functions into independent components. Thus, different functionality can be included in different installations of the same application. This allows product pricing and functionality to be tailored to individual customers. If customers purchase additional product functionality at a later date, it will simply integrate into the application they already have.

The use of a common user interface platform across a range of product functionality promotes consistency that can improve the overall user experience. Basic features such as a common navigation model, single point of access for related tools, and context specific launch points reduce the learning curve for the user and allow them to be more productive. In addition, incorporating multiple products into a single application creates an opportunity for complimentary functionality that is not available when tools are implemented in separate applications.

The UI framework reduces redundant effort by providing services that are common to many application implementations. These services include a main application frame, navigation, toolbars, menus, logging and alert output, options and configuration. In addition to the services provided by the UI framework, the UI framework also provides guidelines for implementation and a repository for reusable source code (i.e. a widget library).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A software framework that integrates user interfaces of a plurality of independent components into a common graphical user interface (GUI), comprising:
a first independent component with a Java core framework and first user interface (UI) elements;
a second independent component with a Java core framework and second UI elements; and
a UI framework that generates said common GUI and that includes a base UI component that communicates with and integrates said first and second UI elements.

2. The software framework of claim 1 wherein said base UI component is a Java core component that generates a base application window.

3. The software framework of claim 2 wherein said base UI component provides a set of common UI services.

4. The software framework of claim 3 wherein said base UI component provides at least one of navigation, toolbars, menu bars, and help functions.

5. The software framework of claim 2 wherein said base application window is a browser-style interface.

6. The software framework of claim 5 wherein said base application window includes a tree panel and a view panel that displays content related to an object that is selected in said tree panel.

7. The software framework of claim 1 wherein said UI framework is a Java class library.

8. The software framework of claim 7 wherein said Java class library of said UI framework is built by a set of tools that are based on JavaSwing components.

9. The software framework of claim 1 wherein one of said first and second independent components is a topology map component.

10. The software framework of claim 1 one of said first and second independent components is a device manager launch component.

11. The software framework of claim 1 one of said first and second independent components is an event display component.

12. A software framework that integrates user interfaces of a plurality independent components into a common graphical user interface (GUI), comprising:
a plurality of independent software components each including user interface (UI) elements; and
a base user interface (UI) component based on a Java class library that supports said common GUI for said first and second independent software components by providing a set of tools based on Java swing components.

13. The software framework of claim 12 wherein said base UI component integrates said first and second user interface elements into said common graphical user interface.

14. The software framework of claim 13 wherein said base UI component provides browser-style navigation.

15. The software framework of claim 14 wherein said browser style navigation includes a tree list, a window that displays an object that is selected in said tree list, and context dependent and independent buttons.

16. The software framework of claim 12 wherein said independent software components have functionality that is built upon a Java core framework.

17. The software framework of claim 16 wherein said Java core framework is a Java class library.

18. The software framework of claim 17 wherein said Java core framework employs a remote method invocation (RMI) standard of Java.

19. The software framework of claim 12 wherein at least one of said independent software components includes a service provider and another of said independent software components includes a service consumer.

20. The software framework of claim 19 wherein said service consumer locates said service provider based on attributes of a desired service.

21. The software framework of claim 20 wherein said service consumer includes a service finder that sends a multicast discovery packet containing a service descriptor.

22. The software framework of claim 21 wherein said service provider includes a service responder that compares said service descriptor in said multicast discovery packet with services provided by said service provider.

23. The software framework of claim 22 wherein said service responder is an object that listens to said multicast discovery packets.
